(19) United States
(12) Patent Application Publication
(10) Pub. No.: US 2006/0017247 A1
(43) Pub. Date: Jan. 26, 2006

(54) Modular rack for storing and transporting gas cylinders

(75) Inventor: Sean Stavros Farley, Woodland Hills, CA (US)

Correspondence Address: KELLY LOWRY & KELLEY, LLP, 6320 CANOGA AVENUE, SUITE 1650, WOODLAND HILLS, CA, 91367, US

(73) Assignee: Discount Carts & Racks Inc., Simi Valley, CA (US)

(21) Appl. No.: 11/163,290

(22) Filed: Oct. 13, 2005

Related U.S. Application Data
(63) Continuation-in-part of application No. 10/790,593, filed on Mar. 2, 2004.

(51) Int. Cl. B62B 1/00

(52) U.S. Cl. 280/79.3

(57) ABSTRACT

A modular rack for storing gas cylinders includes a plurality of vertical posts spaced from one another. Top and bottom frames are removably attached to the posts, and spaced from one another. The top and bottom frames define generally aligned apertures configured to receive gas cylinders therethrough. A stop disposed below the bottom frame aperture supports the gas cylinder thereon.

### BACKGROUND OF THE INVENTION

The present invention generally relates to racks and carts for gas tanks, such as compressed gas cylinders. More particularly, the present invention relates to a modular rack or cart which is assembled for storing such gas cylinders.

There are many gases which are stored in cylindrical tanks for later use. Many of these gases are compressed. Such compressed gas cylinders may contain compressed oxygen for medical or manufacturing purposes, helium, such as for use in childrens' balloons, and other gases, such as those used in welding and the like. Due to the high pressure and the dangers associated with this high pressure, and at times the volatile nature of the contents of the cylinder, OSHA and DOT have set forth safety regulations and placed certain guidelines on the storage and transportation of such compressed gas cylinders. It will be appreciated to those skilled in the art that given the compressed gas within the cylinder, if a cylinder were to fall over and the outlet valve be damaged or broken, the compressed gas would escape and the cylinder could act as a rocket, causing much damage. Accordingly, the proper storage and transportation of these cylinders is very important.

Compressed gas cylinder carts and racks have been designed and manufactured by various companies for many years. However, they are all comprised of welded steel construction. This presents many drawbacks. First, manufacturing of these units is very expensive as it requires a skilled welder to weld all the joints of the cart or rack. Moreover, shipping and storage of these units is very costly as they occupy a large volume.

Accordingly, there is a continuing need for a modular rack or cart for storing gas cylinders which can be transported in a disassembled state so as to save on shipping and storage, yet is easily assembled with little skill and simple tools. The present invention fulfills these needs and provides other related advantages.

### SUMMARY OF INVENTION

The present invention resides in a modular rack or cart adapted to store compressed gas cylinders and the like. The modular rack of the present invention generally comprises a plurality of vertical posts spaced from one another. Typically, the vertical posts consists of four posts spaced from one another in a generally rectangular configuration. A top frame is removably attached to the post. A bottom frame is also removably attached to the posts, and spaced vertically from the top frame.

The top frame and bottom frames each define at least one aperture configured to receive a gas cylinder therethrough. These apertures are aligned with one another so as to receive a gas cylinder. A stop extends from the bottom frame and is disposed below the bottom frame aperture to support the gas cylinder thereon.

Typically, the top and bottom frames each comprise a peripheral wall. A plurality of rods extend between first and second sides thereof in overlapping nature to form at least one aperture of the frames.

In a particularly preferred embodiment, the vertical posts each include a plurality of spaced apart grooves formed in an outer surface thereof. A sleeve is removably attached to each vertical post and adapted to engage the top or bottom frame. Preferably, the sleeve is comprised of first and second snap-fit portions.

The sleeve is frictionally attached to the vertical post and frictionally engaged with the connector of the top or bottom frame. Such connector typically comprises a tube defining an aperture configured to be inserted over the post and into engagement with the sleeve.

Another embodiment of the present invention comprises a cart adapted for transporting the gas cylinders, wherein a wheel is removably associated with each post. Also, preferably, a generally U-shaped handle extends between two adjacent posts.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a modular rack for storing gas cylinders, embodying the present invention;

FIG. 2 is an exploded perspective view illustrating the attachment of a bottom frame to posts of the rack;

FIG. 3 is a partially exploded and enlarged perspective view, illustrating sleeves of the present invention being attached to a post of the rack of the present invention;

FIG. 4 is a partially exploded perspective view illustrating a top frame being attached to the posts in accordance with the present invention;

FIG. 5 is a perspective view of another modular cart for storing and transporting gas cylinders embodying the present invention;

FIG. 6 is a partially exploded perspective view illustrating a top frame being attached to posts of the cart, in accordance with the present invention;

FIG. 7 is a partially exploded perspective view illustrating a bottom frame being connected to the posts, in accordance with the present invention; and

FIG. 8 is a partially exploded perspective view, illustrating casters being attached to bottom ends of the posts, in accordance with the present invention.

### DETAILED DESCRIPTION OF THE PREFERRED EMBODIMENTS

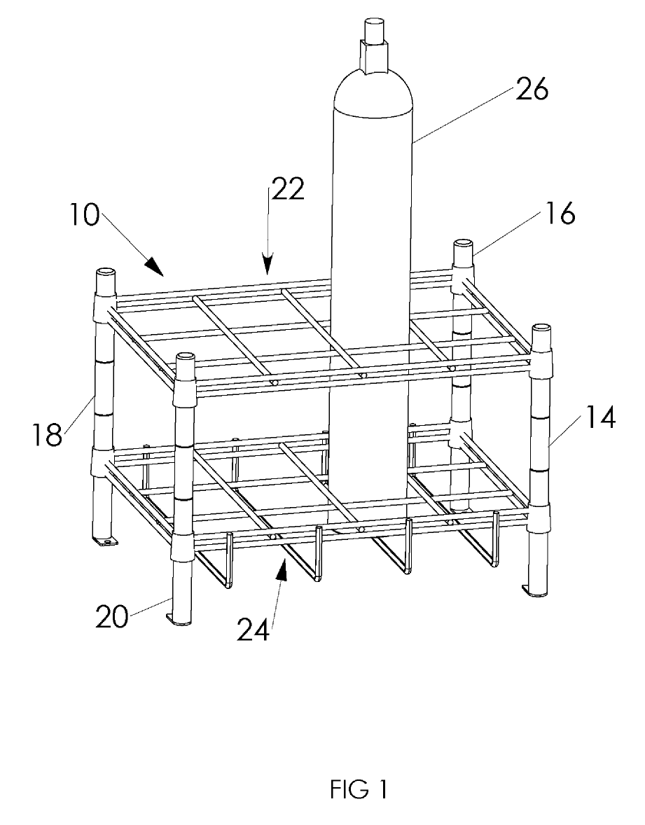

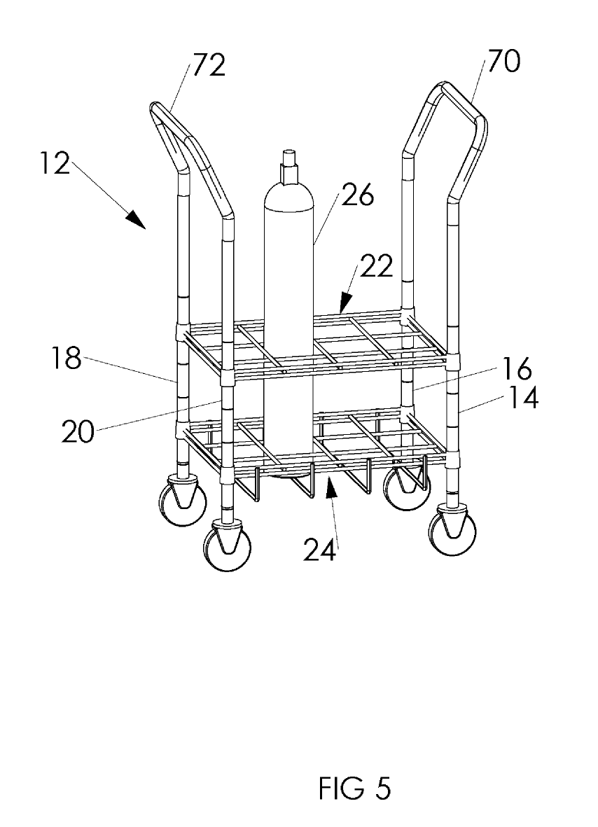

As shown in the accompanying drawings, for purposes of illustration, the present invention is directed to a modular rack or cart, generally referred to by the reference number 10 in FIGS. 1-4, and by the reference number 12 in FIGS. 5-8. A benefit of the rack or cart 10 and 12 of the present invention is that it is designed so as to be modular. That is, various components thereof are removably attached to one another such that the rack or cart 10 and 12 can be fairly compact when not assembled for storage and transport. As described above, such racks or carts are typically offered as a single unit. This requires a significant amount of welds between the various metallic components thereof. Also, the containers required to ship such carts or racks are very large, increasing the shipping costs significantly and requiring extra storage space in the warehouse, etc. The rack or cart 10 and 12 of the invention overcomes these disadvantages.

With reference now to FIG. 1, the rack, in one embodiment of the invention, includes a plurality, typically four, posts 14-20, which are oriented vertically, and spaced apart from one another so as to form a generally rectangular configuration. A top frame 22 and a bottom frame 24 are removably attached to the posts 14-20 and spaced apart from one another. The top and bottom frames 22 and 24 cooperatively support and hold a gas cylinder 26. Such gas cylinders 26 are typically compressed gas cylinders, such as carbon dioxide metallic tanks, oxygen metallic tanks, compressed air tanks, etc.

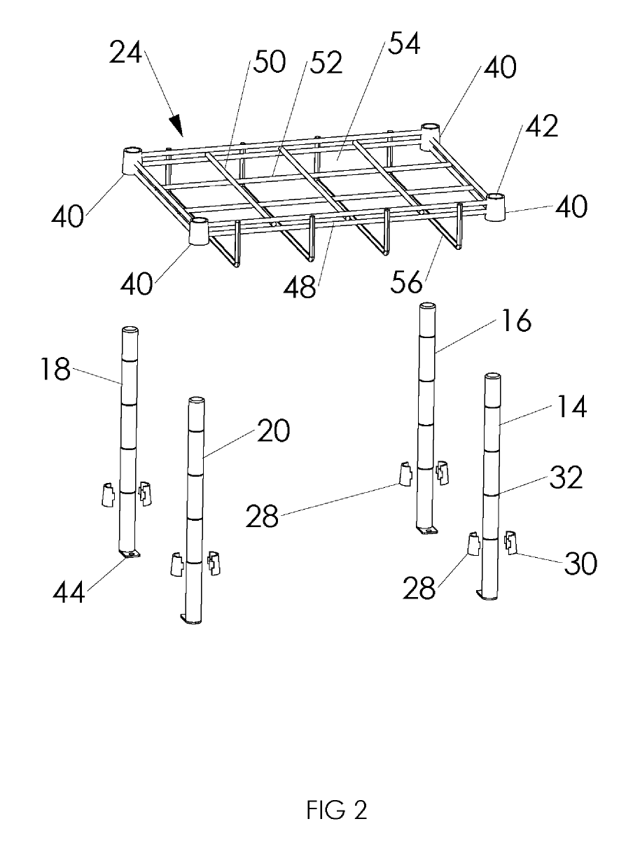

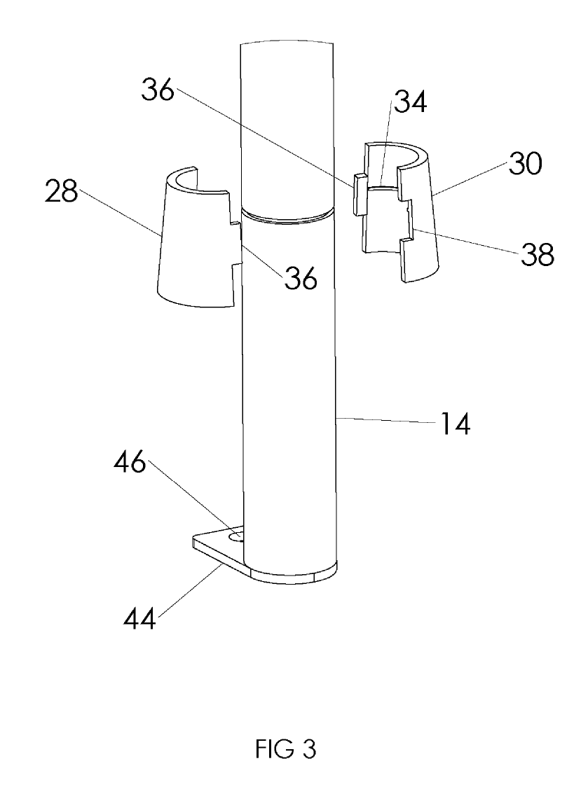

With reference now to FIGS. 2 and 3, as described above, the rack 10 comes disassembled. In order to assemble the rack 10, the posts 14-20 are spaced apart from one another, described above. A plurality of sleeves, one for each post 14-20 is provided. These sleeves are removably attached to each vertical post 14-20, and adapted to engage the bottom frame 24, as will be more fully discussed herein. In particular, the sleeves are formed of two half portions 28 and 30, which snap-fit to one another around the outer surface of the post 14-20.

With particular reference to FIG. 3, each post 14-20 includes a plurality of grooves 32 formed in an outer surface thereof and spaced apart from one another. Each sleeve half 28 and 30 includes a projection, typically in the form of a ring 34 which is adapted to fit within the groove 32. Thus, as the two halves 28 and 30 are pressed against one another, the ring 34 rests within the groove 32. The sleeve halves 28 and 30 preferably snap-fit to one another. This is accomplished by having a male projection 36 and a corresponding female notch or the like 38 which is adapted to receive the male projection 36 in frictional fit. The important aspect in accordance with the present invention is that the sleeve is removably attached to the post 14-20 in a manner which will serve as a stop for the bottom frame 24.

Referring again to FIG. 2, the bottom frame 24 includes a connector 40 at each corner thereof which is tubular in nature so as to include a passageway 42 therethrough. The passageway 42 is sized such so as to easily slide over the posts 14-20, and frictionally fit over the sleeve halves 28 and 30. Typically, the sleeve halves 28 and 30 are slightly tapered. Thus, the connectors 40 can easily slide over a top portion of the sleeve 28 and 30, and increasingly form a friction fit as it is pressed downwardly over the sleeve 28 and 30, which also maintains the sleeve halves 28 and 30 in frictional contact with each other and the posts 14-20. Striking the bottom frame 24 with a rubber mallet or hammer forms a tight connection.

In order to provide additional stability, feet or tabs 44 extend outwardly from the bottom of each post 14-20. Preferably, these feet 44 also include an aperture 46 therethrough through which a fastener, such as a bolt, can be passed through and into a floor or the like so as to securely hold the rack 10 in place without fear of tipping over.

The bottom rack 24 includes a side wall 48, illustrated as two parallel rods extending around the periphery of the bottom frame 24. The bottom frame 24 typically has a square or rectangular configuration, with opposing ends and sides. At least one, and typically a plurality, of rods 50 extend from the opposing side walls 48. Similarly, a plurality of rods 52 extend from ends of the wall 48 so as to overlap with the rods 50. The result is the formation of one or more apertures 54 which have a sufficient dimension so as to receive the cylinder 26 therethrough, as illustrated in FIG. 1. One or more stops 56 is disposed below the apertures 54. Typically, the stop 56 comprises a rod extending from side wall to side wall and below the apertures 54, for supporting the cylinder 26 thereon, as illustrated in FIG. 1.

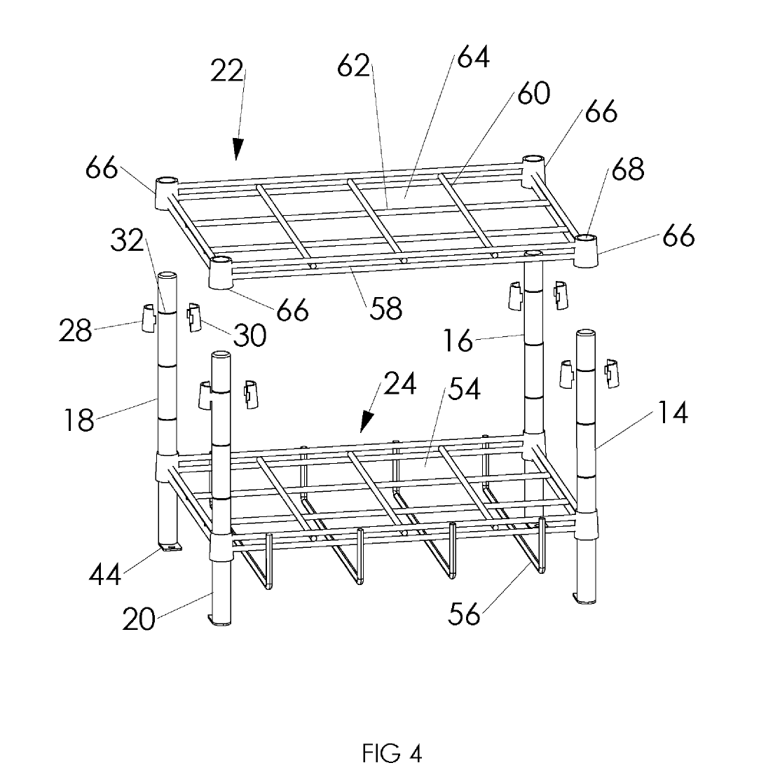

With reference now to FIG. 4, the top frame 22 is removably attached to the post 14-20 in a similar manner. That is, the sleeves halves 28 and 30 are engaged with one another about a groove 32 of the individual posts 14-20 in spaced relation from the bottom frame 24. Preferably, multiple grooves 32 are formed along each post 14-20, such that the space between the bottom and top frames 24 and 22 can be adjusted to meet the length of the gas cylinder 26 to be held thereby.

Similar to the bottom frame 24, the top frame 22 includes a side wall 58, rods 60 and 62 in overlapping relation to form one or more apertures 64 adapted to receive the gas cylinder 26 therethrough. It will be appreciated that the apertures 54 and 64 are generally aligned with one another when the frames 22 and 24 are installed on the posts 14-20. The top frame 22 also includes connectors 66 with the passageway 68 therethrough so as to engage the sleeve halves 28 and 30 as described above.

With reference now to FIGS. 5-8, another embodiment of the present invention is shown. The rack has been converted to a cart 12, which instead of being stationery and fixed in place is movable. Similar reference numbers will be used for similar parts between the rack and the cart 12.

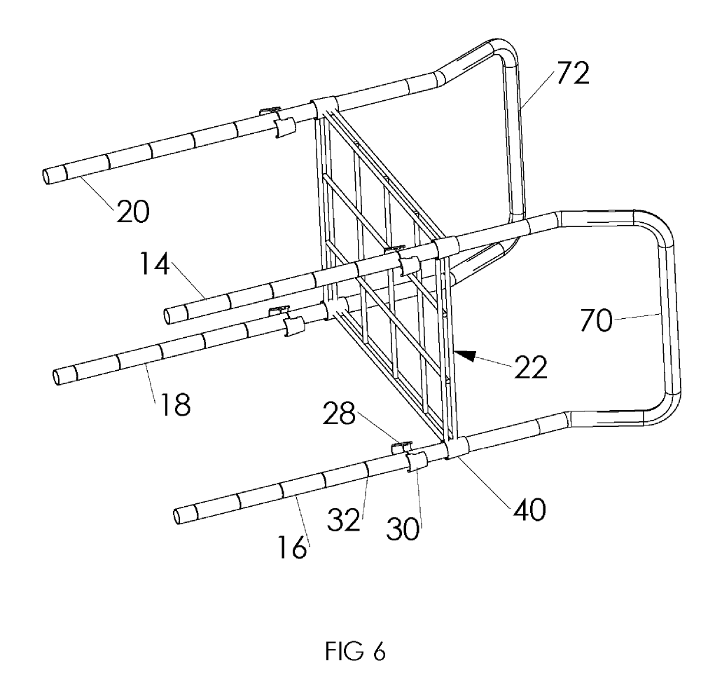

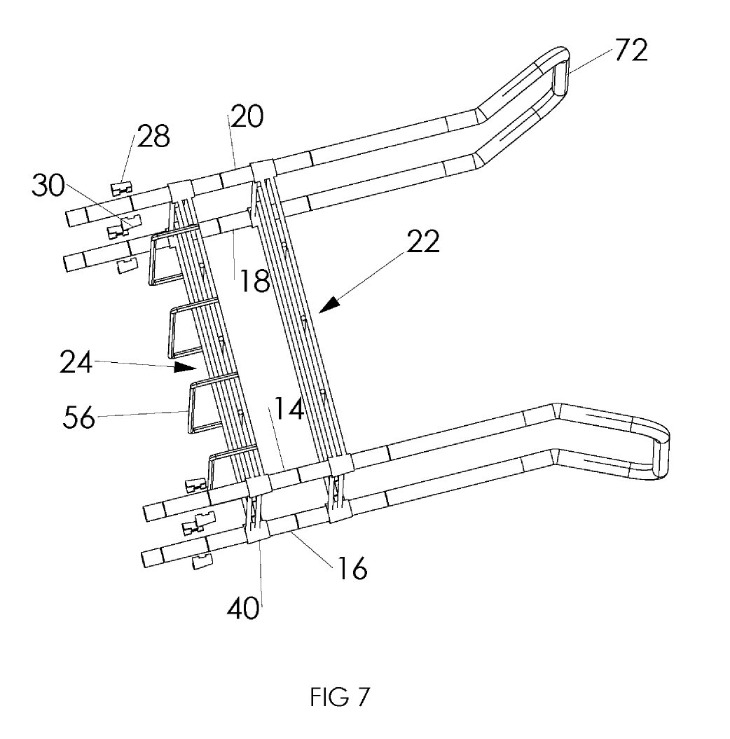

In this embodiment, a generally U-shaped handle 70 extends between the two adjacent posts 14 and 16. Similarly, a handle 72 extends between the adjacent posts 18 and 20. Although the handle 70 and 72 could be removably attached to the top portion of the posts 14-20, more typically, the handle 70 or 72 is formed integrally with the posts 14-20, so as to be made from a single piece of tubing. With reference to FIG. 6, when the handles 70 and 72 are formed integrally with the posts 14-20, the top frame 22 is first inserted over the posts 14-20. The sleeves 28 and 30 are then connected to one another around a groove 32, and the top frame 22 forced into frictional fit therewith by sliding the frame 22 over the posts 14-20 and into engagement with the sleeve halves 28 and 30. Similar steps are taken in attaching the bottom frame 24 to the posts 14-20, as illustrated in FIG. 7.

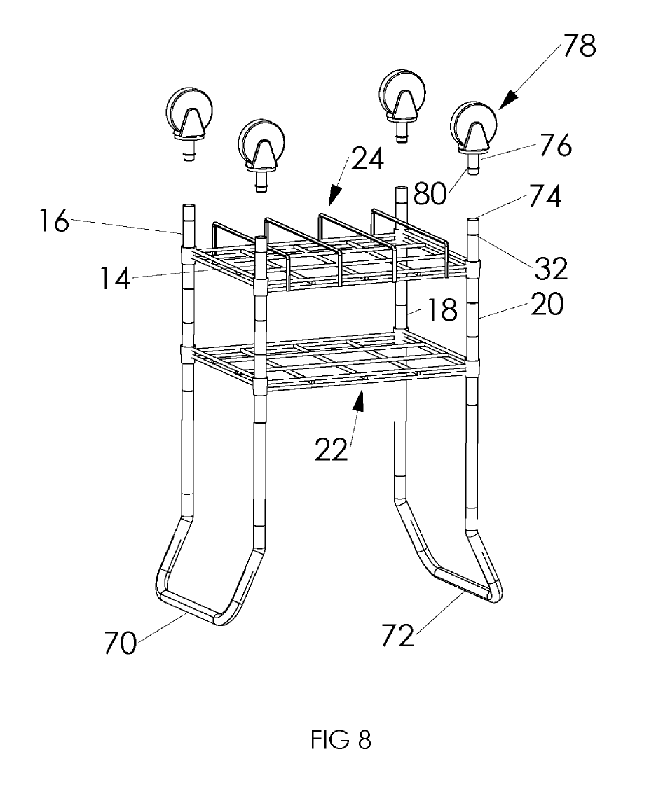

With reference now to FIG. 8, with the top frame 22 and bottom frame 24 secured to the posts 14-20, the unit 12 is inverted such that the handles 70 and 72 rest on the floor. The posts 14-20 are hollow, or include an open end 74 adapted to receive a post 76 of a caster wheel 78. The shaft 76 includes protrusions, typically in the form of a ring 80 which serves as a grip. As the caster post or stem 76 is pushed inside of the tubing 74, the ring 80 slips into and above the groove 32 of the posts 14-20 to secure the wheel 78 thereto.

From the foregoing, those skilled in the art will appreciate that the present invention is cheaper to manufacture, and ship and store. The rack and cart 10 and 12 of the present invention are easily assembled without the need for complex tools or training. However, the resulting rack and cart 10 and 12 are stable and sturdy when assembled.

Although several embodiments have been described in detail for purposes of illustration, various modifications may be made without departing from the scope and spirit of the invention. Accordingly, the invention is not to be limited, except as by the appended claims.

What is claimed is:

1. A modular rack for storing gas cylinders, comprising:
a plurality of vertical posts spaced from one another;
a top frame removably attached to the posts, the top frame defining at least one aperture configured to receive a gas cylinder therethrough;
a bottom frame removably attached to the posts and spaced vertically from the top frame, the bottom frame defining at least one aperture configured to receive a gas cylinder therethrough, the bottom frame aperture being aligned with the top frame aperture; and
a stop extending from the bottom frame and disposed below the bottom frame aperture for supporting a gas cylinder thereon.

2. The modular rack of claim 1, wherein the plurality of vertical posts consist of four posts spaced from one another in a generally rectangular configuration.

3. The modular rack of claim 1, wherein the vertical posts each include a plurality of spaced apart grooves formed in an outer surface thereof.

4. The modular rack of claim 1, including a sleeve removably attached to each vertical post and adapted to engage the top or bottom frame.

5. The modular rack of claim 4, wherein the sleeve is comprised of first and second snap-fit portions.

6. The modular rack of claim 4, wherein the sleeve is frictionally attached to the vertical post, and frictionally engaged with a connector of the top or bottom frame.

7. The modular rack of claim 6, wherein the top and bottom frame connectors each comprise a tube defining an aperture configured to be inserted over the post and into engagement with the sleeve.

8. The modular rack of claim 1, wherein the top and bottom frames each comprise a peripheral wall having a plurality of rods extending between first opposite sides thereof, and a plurality of rods extending between second opposite sides thereof, the rods overlapping to form the at least one aperture of the top and bottom frame.

9. The modular rack of claim 1, including a wheel operably associated with each post.

10. The modular rack of claim 9, including a generally U-shaped handle extending between two adjacent posts.

11. A modular rack for storing gas cylinders, comprising:
a plurality of vertical posts spaced from one another in a generally rectangular configuration;
first and second sleeves frictionally attached to each vertical post in spaced relation;
a top frame having a plurality of connectors frictionally engaged with the first sleeves so as to be attached to the posts, the top frame defining at least one aperture configured to receive a gas cylinder therethrough;
a bottom frame having a plurality of connectors frictionally engaged with the second sleeves so as to be attached to the posts, the bottom frame being spaced vertically from the top frame, and defining at least one aperture configured to receive a gas cylinder therethrough, the bottom frame aperture being aligned with the top frame aperture; and
a stop extending from the bottom frame and disposed below the bottom frame aperture for supporting a gas cylinder thereon.

12. The modular rack of claim 11, wherein the vertical posts each include a plurality of spaced apart grooves formed in an outer surface thereof.

13. The modular rack of claim 11, wherein the sleeve is comprised of first and second snap-fit portions.

14. The modular rack of claim 11, wherein the top and bottom frame connectors each comprise a tube defining an aperture configured to be inserted over the post and into engagement with the sleeve.

15. The modular rack of claim 11, wherein the top and bottom frames each comprise a peripheral wall having a plurality of rods extending between first opposite sides thereof, and a plurality of rods extending between second opposite sides thereof, the rods overlapping to form the at least one aperture of the top and bottom frame.

16. A modular cart for storing and transporting gas cylinders, comprising:
a plurality of vertical posts spaced from one another in a generally rectangular configuration;
first and second sleeves frictionally attached to each vertical post in spaced relation;
a top frame having a plurality of connectors frictionally engaged with the first sleeves so as to be attached to the posts, the top frame defining at least one aperture configured to receive a gas cylinder therethrough;
a bottom frame having a plurality of connectors frictionally engaged with the second sleeves so as to be attached to the posts, the bottom frame being spaced vertically from the top frame, and defining at least one aperture configured to receive a gas cylinder therethrough, the bottom frame aperture being aligned with the top frame aperture;
a stop extending from the bottom frame and disposed below the bottom frame aperture for supporting a gas cylinder thereon;
a wheel operably associated with each post; and
a generally U-shaped handle extending between two adjacent posts.

17. The modular rack of claim 16, wherein the vertical posts each include a plurality of spaced apart grooves formed in an outer surface thereof.

18. The modular rack of claim 16, wherein the sleeve is comprised of first and second snap-fit portions.

19. The modular rack of claim 16, wherein the top and bottom frame connectors each comprise a tube defining an aperture configured to be inserted over the post and into engagement with the sleeve.

20. The modular rack of claim 16, wherein the top and bottom frames each comprise a peripheral wall having a plurality of rods extending between first opposite sides thereof, and a plurality of rods extending between second opposite sides thereof, the rods overlapping to form the at least one aperture of the top and bottom frame.
